(19) United States
(12) Patent Application Publication
(10) Pub. No.: US 2011/0077767 A1
(43) Pub. Date: Mar. 31, 2011

(54) SYSTEM FOR TEMPORARILY SUPPLYING POWER AND A METHOD THEREOF

(75) Inventors: HUNG-CHIN CHEN, TAIPEI CITY (TW); WEN-YU FANG, TAIPEI COUNTY (TW)

(73) Assignee: INOTERA MEMORIES, INC., TAOYUAN COUNTY (TW)

(21) Appl. No.: 12/788,556

(22) Filed: May 27, 2010

(30) Foreign Application Priority Data
Sep. 30, 2009 (TW) 98133201

(51) Int. Cl. G06F 19/00; G06F 1/28

(52) U.S. Cl. 700/112; 700/121; 700/295

(57) ABSTRACT

The method for temporarily supplying electric power includes steps of: providing a system which has a power supplying unit and a controlling unit for applying a temporary power to a broken semiconductor carrier of the semiconductor carrying facility; utilizing the power supplying unit to supply electric power to the broken semiconductor carrier; and utilizing the controlling unit to control movements of the broken semiconductor carrier. Thereby, the broken semiconductor carrier can be driven to a maintain area efficiently and safely.

### BACKGROUND OF THE INVENTION

1. Field of the Invention

The present invention is a system for temporarily supplying power and method thereof; especially, the present invention relates to a system and a method for temporarily supplying electric power to a broken semiconductor carrier and to drive the broken semiconductor carrier from the track to a maintain area.

2. Description of Related Art

It is necessary to transfer the chip devices carefully before the manufactured micro chip is packaged because of the brittleness of wafers which are made of silicon or GaAs materials. The transferring method and tools are more stable to keep the manufactured wafer products.

In the recently wafer manufacturing application, the automatic transferring system has been widely to transfer the wafers efficiently. Generally, the system has transferring carriers move on the tracks for transferring wafer materials and wafer products between the working areas.

However, when one of the transferring carriers cannot receive the electric power of the main system, the broken transferring carrier stops on the track. Therefore, the stopped transferring carrier results in the transferring failure because the normal transferring carriers are blocked by the broken transferring carrier. The traditional method for removing the broken transferring carrier is pushing the broken transferring carrier by human labor. Due to the position of the transferring carrier, a tool, for example a pole is used to push and drive the broken transferring carrier. Further regarding the weight of the transferring carrier, it is hard to drive the broken transferring carrier by hand-tools (i.e., the pole) and human labor. On the other hand, the above-mentioned method may cause the working-safety issue.

Consequently, with regard to the resolution of defects illustrated hereinbefore, the inventors of the present invention propose a reasonably designed solution for effectively eliminating such defects.

### SUMMARY OF THE INVENTION

The objective of the present invention is to provide a system and a method of temporary electric power to broken semiconductor carrier(s) and controlling the movements of the broken semiconductor carrier(s). Thus, the broken semiconductor carrier can be removed efficiently and safely to the maintain area and the manufacturing line can be reinstated to a normal situation.

To achieve the objective described as above, the present invention discloses a system for applying a temporary power to a broken semiconductor carrier. The system includes a casing, a power supplying unit and a controlling unit. The power supplying unit is disposed in the casing and supplies an electric power to the broken semiconductor carrier. The controlling unit is disposed in the casing and controls the movements of the broken semiconductor carrier.

The present invention further discloses a method for applying temporary power to a broken semiconductor carrier. The method has the steps of providing at least one semiconductor carrier moving along with a main track and a plurality of branching tracks; when the semiconductor carrier is broken (i.e., failure of receiving main electric power), providing a system for temporarily supplying power to the broken semiconductor carrier, wherein the system includes a power supplying unit and a controlling unit; utilizing the power supplying unit of the system to supply electric power to the broken semiconductor carrier; and utilizing the controlling unit of the system to control movements of the broken semiconductor carrier. Therefore, the broken semiconductor carrier is powered and controlled to move to a maintain area, and the semiconductor carrying facility can be operated normally.

The system of the present invention is used in a method to apply temporary power to a broken semiconductor carrier and the powered semiconductor carrier can be controlled to move along with the tracks. Thus, the broken semiconductor carrier can be removed from the tracks. Moreover, the method and the system of the present invention provide electric power to drive the broken semiconductor carrier on the track so that the safety is achieved when the broken semiconductor carrier is driven to move to the maintain area.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a diagram of the semiconductor carrying facility according to the present invention.

FIG. 2 is a diagram of the semiconductor carrier moving on the track according to the present invention.

FIG. 2A is a diagram of the system of the present invention applied to the broken semiconductor carrier according to the present invention.

FIG. 3 is a circuit diagram of the system according to the present invention.

FIG. 4 is a flow chart of the method according to the present invention.

### DETAILED DESCRIPTION OF THE PREFERRED EMBODIMENTS

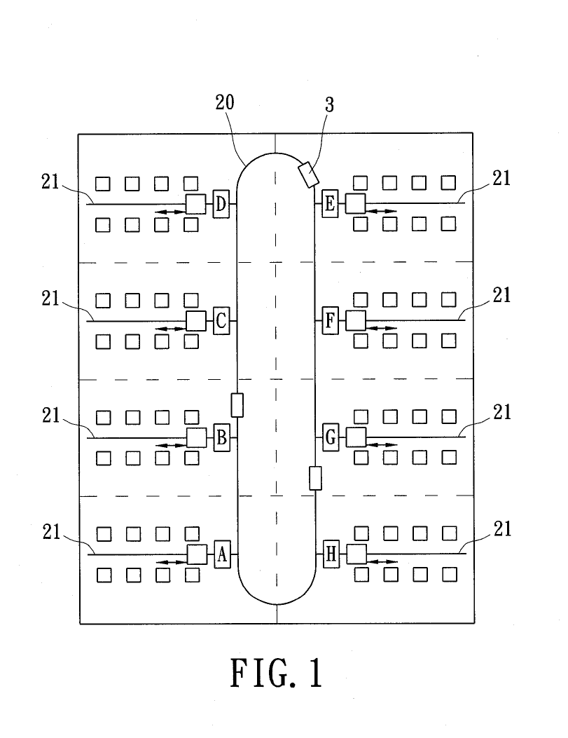

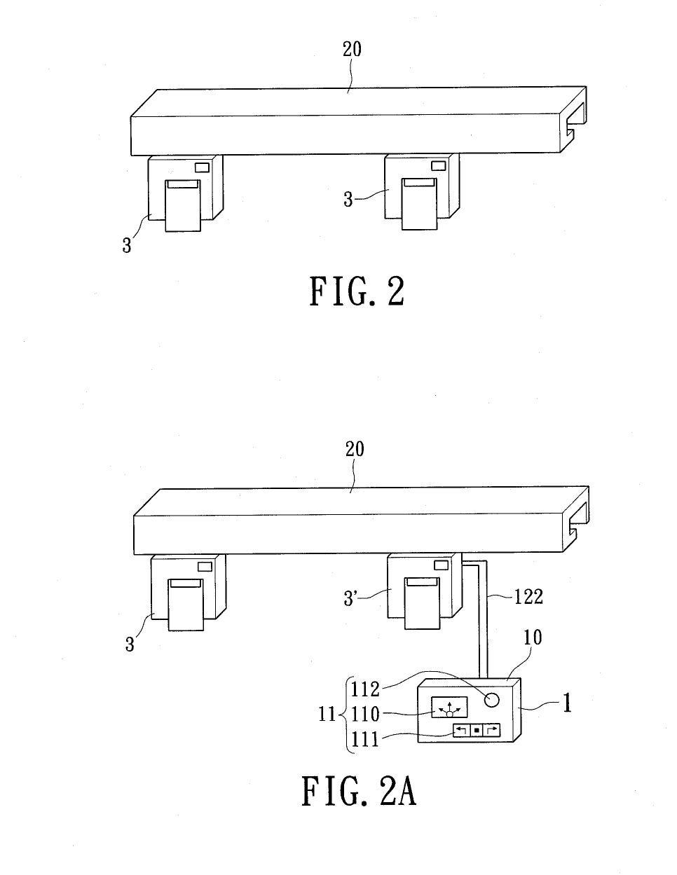

Refer now to FIG. 1 to FIG. 2A, the present invention provides a system 1 and a method for temporarily supplying power. The system 1 can be used for applying a temporary power to a broken semiconductor carrier 3′ so that the broken semiconductor carrier 3′ can be powered on and be driven to a maintain area. In other words, the broken semiconductor carrier 3′ can be safely and efficiently removed from the semiconductor carrying facility so as to transfer the other semiconductor carrier 3. For example, the semiconductor carrying facility can be an overhead hoist transport (OHT) system and the OHT carriers move along with a track to a store position. The system 1 and the method is used in the OHT system as following, but not restricted thereby.

As shown in FIGS. 1 and 2, there are a main track 20 and a plurality of branching tracks 21 in a semiconductor manufacturing line. For example, semiconductor carriers 3 moves along with the main track 20 and the branching tracks 21 to transfer the semiconductor materials from working station A to working station H. When a semiconductor carriers 3 cannot receive the electric power (i.e. the broken semiconductor carrier 3′ in FIG. 2A) and the broken semiconductor carrier 3′ cannot controlled by the main controlling system, the system 1 and a method of the present invention can be used for removing the broken semiconductor carrier 3′ from the tracks 20, 21.

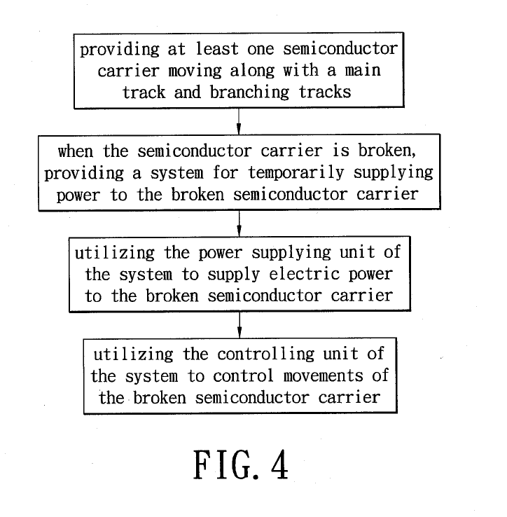

Please refer to FIGS. 2A, 3 and 4; the system 1 includes a controlling unit 11 and a power supplying unit 12. The controlling unit 11 and the power supplying unit 12 are preferably accommodated in a casing 10 so that the system 1 can be carried by hands or on the user's back to the position close to the broken semiconductor carrier 3′. In other words, the controlling unit 11 and the power supplying unit 12 are integrated into the casing 10 and it is convenient for a user to carry the system 1 to the position close to the broken semiconductor carrier 3′.

The power supplying unit 12 supplies an electric power to the broken semiconductor carrier 3′. In the embodiment, the power supplying unit 12 has a rechargeable battery 120, a displaying device 121 and an output connector 122. The rechargeable battery 120 supplies the electric power to the broken semiconductor carrier 3′ and the displaying device 121 is connected electrically to the rechargeable battery 120. Therefore, the user can know the power left in the rechargeable battery 120 by the indication of the displaying device 121. The output connector 122 is a signal/power transferring device which extends out of the casing 10. For example, the output connector 122 can be a conductive wire with a plug so that the plug can be plugged into the broken semiconductor carrier 3′ so that the electric power and the controlling signals can be received by the broken semiconductor carrier 3′.

The controlling unit 11 controls movements of the broken semiconductor carrier 3′. The broken semiconductor carrier 3′ (or the normal semiconductor carrier 3) has a main motor 31 and at least one auxiliary motor 32. The broken semiconductor carrier 3′ (or the normal semiconductor carrier 3) can move straightly along with the tracks 20, 21 by the main motor 31, and the broken semiconductor carrier 3′ (or the normal semiconductor carrier 3) can turn left or right by the auxiliary motor 32. In other words, the broken semiconductor carrier 3′ can move from the main track 20 to one of the branching tracks 21 by controlling the auxiliary motor 32, or the broken semiconductor carrier 3′ can move from the branching track 21 to the main track 20 by controlling the auxiliary motor 32. In other words, the rechargeable battery 120 supplies power to the main motor 31 and the auxiliary motor 32, and the controlling unit 11 controls movements of the main motor 31 and the auxiliary motor 32 of the broken semiconductor carrier 3′.

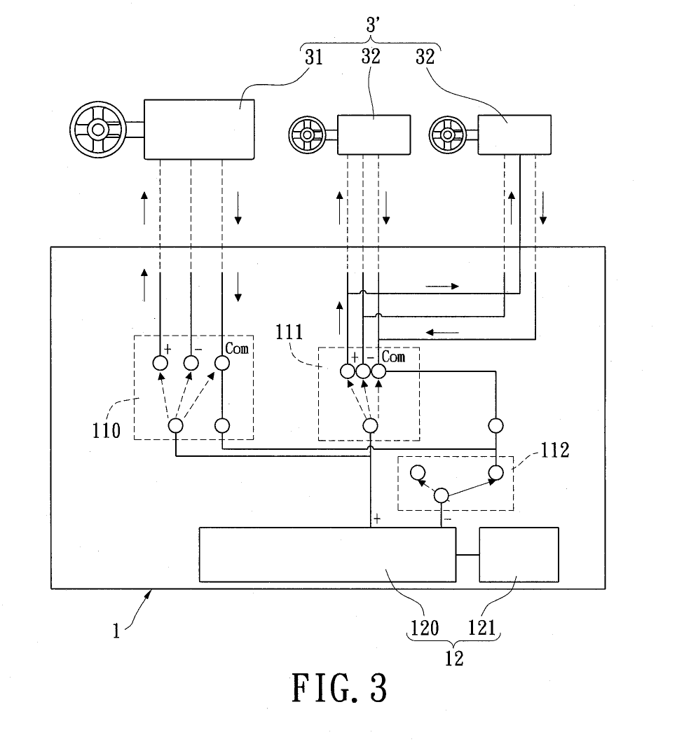

In the embodiment, the controlling unit 11 has a main motor controlling interface 110, an auxiliary motor controlling interface 111 and an emergency switch 112. The main motor controlling interface 110, the auxiliary motor controlling interface 111 and the emergency switch 112 are disposed on the casing 10 so that the user can use the main motor controlling interface 110, the auxiliary motor controlling interface 111 and the emergency switch 112 to control the broken semiconductor carrier 3′. Please refer to FIG. 3; the main motor controlling interface 110 is used to switch the electric power of the rechargeable battery 120 for controlling the movements of the main motor 31 so that the broken semiconductor carrier 3′ moves backward or forward along with the main track 20. The auxiliary motor controlling interface 111 to switch the electric power of the rechargeable battery 120 for controlling the movements of the auxiliary motor 32 so that the broken semiconductor carrier 3′ can turn left or right. The emergency switch 112 cuts off electric power of the rechargeable battery 120 to the main motor 31 and the auxiliary motor 32 so as to stop the main motor 31 and the auxiliary motor 32.

Therefore, the power supplying unit 12 can supply power to the broken semiconductor carrier 3′ and the controlling unit 11 can control the movements of the broken semiconductor carrier 3′ so that the broken semiconductor carrier 3′ can be safely and efficiently driven to the maintain area. Thus, the operation of the manufacturing line can be efficiently reinstated and the working-safety issue is prevented.

The method for removing the broken semiconductor carrier 3′ is shown below.

In general, the semiconductor carriers 3 move along with the main track 20 and the branching tracks 21 to transfer the semiconductor materials, tools or products/half-finished products.

When the main power cannot be received by a semiconductor carrier 3 (i.e., the semiconductor carrier 3 fails to receive the power, not the moving mechanism of the semiconductor carrier 3), a user can carry the system 1 to the position of the broken semiconductor carrier 3′ and the output connector 122 of the power supplying unit 12 is connected to the broken semiconductor carrier 3′. For example, the output connector 122 is plugged into the power socket of the broken semiconductor carrier 3′ so that the power of the rechargeable battery 120 is supplied to the broken semiconductor carrier 3′ and the broken semiconductor carrier 3′ is controlled by the controlling unit 11. Therefore, the broken semiconductor carrier 3′ can be removed form the tracks 20, 21 to the maintain area.

The detail steps are shown below:

The Step is utilizing the main motor controlling interface 110 of the controlling unit 11 to switch the electric power supplied to the main motor 31 for controlling the movements of the main motor 31 so that the broken semiconductor carrier 3′ moves backward or forward along with the main track 20. Thus, the broken semiconductor carrier 3′ can be controlled to move to the maintain area.

In another situation, the first step is utilizing the main motor controlling interface 110 of the controlling unit 11 to switch the electric power supplied to the main motor 31 for controlling the movements of the main motor 31 so that the broken semiconductor carrier 3′ moves backward or forward along with the main track 20. Next step is utilizing the auxiliary motor controlling interface 111 to switch the electric power supplied to the auxiliary motor 32 for controlling the movements of the auxiliary motor 32 so that the broken semiconductor carrier 3′ turns form the main track 20 to one of the branching tracks 21. Thus, the broken semiconductor carrier 3′ can be controlled to move to the maintain area. Alternatively, when the semiconductor carrier 3 fails on one branching track 21, the following steps are provided for removing the broken semiconductor carrier 3′. The first step is utilizing the auxiliary motor controlling interface 111 to switch the electric power supplied to the auxiliary motor 32 for controlling the movements of the auxiliary motor 32 so that the broken semiconductor carrier 3′ turns form one of the branching tracks 21 to the main track 20. Next step is utilizing the main motor controlling interface 110 to switch the electric power supplied to the main motor 31 for controlling the movements of the main motor 31 so that the broken semiconductor carrier 3′ moves backward or forward along with the main track 21. Thus, the broken semiconductor carrier 3′ can be controlled and driven to move to the maintain area. However, the method is not restricted thereby.

On the other hand, an emergency step of utilizing the emergency switch 112 to stop the main motor 31 and the auxiliary motor 32 is provided for preventing emergency situation.

In summary of aforementioned descriptions, the present invention can provide the following advantages:

1. The system and the method disclosed in the present invention can provide more safety to remove the broken semiconductor carrier. The user can carry the system to the position of the broken semiconductor carrier so as to supply electric power to the broken semiconductor carrier and drive the broken semiconductor carrier. Therefore, the broken semiconductor carrier can be efficiently removed from the tracks and the transferring system can operate normally.

2. The system and the method of the present invention can be used in various materials carrying facility, such as semiconductor manufacturing line or the LCD manufacturing system.

The texts set forth hereinbefore illustrate simply the preferred embodiments of the present invention, rather than intending to restrict the scope of the present invention claimed to be legally protected thereto. All effectively equivalent changes made by using the contents of the present disclosure and appended drawings thereof are included within the scope of the present invention delineated by the following claims.

What is claimed is:

1. A system for temporarily supplying power in semiconductor carrying facility, the system applying a temporary power to a broken semiconductor carrier of the semiconductor carrying facility, the system comprising:
a casing;
a power supplying unit disposed in the casing, wherein the power supplying unit supplies an electric power to the broken semiconductor carrier of the semiconductor carrying facility; and
a controlling unit disposed in the casing, the power supplying unit being electrically connected to the controlling unit, wherein the controlling unit controls movements of the broken semiconductor carrier of the semiconductor carrying facility.

2. The system according to claim 1, wherein the power supplying unit further comprises an output connector and the output connector is plugged on the broken semiconductor carrier.

3. The system according to claim 2, wherein the casing is used to be carried by a user for a position of the broken semiconductor carrier.

4. The system according to claim 2, wherein the power supplying unit includes a rechargeable battery and a displaying device, and the rechargeable battery supplies the electric power to the broken semiconductor carrier via the output connector.

5. The system according to claim 4, wherein the broken semiconductor carrier has a main motor and at least one auxiliary motor, and the rechargeable battery supplies the electric power to the main motor and the auxiliary motor.

6. The system according to claim 5, wherein the controlling unit has a main motor controlling interface, an auxiliary motor controlling interface and an emergency switch.

7. The system according to claim 6, wherein the main motor controlling interface is used for switching the electric power supplied by the rechargeable battery to the main motor so as to control movements of the main motor.

8. The system according to claim 6, wherein the auxiliary motor controlling interface is used for switching the electric power supplied by the rechargeable battery to the auxiliary motor so as to control movements of the auxiliary motor.

9. The system according to claim 6, wherein the emergency switch is used for turning off the electric power supplied by the rechargeable battery to the main motor and the auxiliary motor so as to stop movements of the main motor and the auxiliary motor.

10. A method for temporarily supplying power in semiconductor carrying facility for removing a broken semiconductor carrier of the semiconductor carrying facility, the method comprising steps of:
providing at least one semiconductor carrier moving along with a main track and a plurality of branching tracks;
when the semiconductor carrier is broken, providing a system for temporarily supplying power to the broken semiconductor carrier, wherein the system includes a power supplying unit and a controlling unit;
utilizing the power supplying unit to supply electric power to the broken semiconductor carrier; and
utilizing the controlling unit to control movements of the broken semiconductor carrier;
whereby, the broken semiconductor carrier is temporarily powered and controlled to move to a maintain area.

11. The method according to claim 10, wherein the power supplying unit includes a rechargeable battery, a displaying device and an output connector, and the output connector is electrically connected to the broken semiconductor carrier for transmitting the electric power to the broken semiconductor carrier in the step of utilizing the power supplying unit to supply electric power to the broken semiconductor carrier.

12. The method according to claim 11, wherein the broken semiconductor carrier has a main motor and at least one auxiliary motor, and the rechargeable battery supplies the electric power to the main motor and the auxiliary motor via the output connector, and the output connector is electrically connected to the main motor and the auxiliary motor of the broken semiconductor carrier in the step of utilizing the power supplying unit to supply electric power to the broken semiconductor carrier.

13. The method according to claim 12, wherein the controlling unit has a main motor controlling interface, an auxiliary motor controlling interface and an emergency switch, and the step of utilizing the controlling unit to control movements of the broken semiconductor carrier further comprises steps of:
utilizing the main motor controlling interface to switch the electric power for controlling the movements of the main motor so that the broken semiconductor carrier moves backward or forward along with the main track; and
driving the broken semiconductor carrier to the maintain area.

14. The method according to claim 12, wherein the controlling unit has a main motor controlling interface, an auxiliary motor controlling interface and an emergency switch, and the step of utilizing the controlling unit to control movements of the broken semiconductor carrier further comprises steps of:
utilizing the main motor controlling interface to switch the electric power for controlling the movements of the main motor so that the broken semiconductor carrier moves backward or forward along with the main track;
utilizing the auxiliary motor controlling interface to switch the electric power for controlling the movements of the auxiliary motor so that the broken semiconductor carrier turns form the main track to one of the branching tracks; and
driving the broken semiconductor carrier to the maintain area.

15. The method according to claim 12, wherein the controlling unit has a main motor controlling interface, an auxiliary motor controlling interface and an emergency switch, and the step of utilizing the controlling unit to control movements of the broken semiconductor carrier further comprises steps of:
utilizing the auxiliary motor controlling interface to switch the electric power for controlling the movements of the auxiliary motor so that the broken semiconductor carrier turns form one of the branching tracks to the main track;
utilizing the main motor controlling interface to switch the electric power for controlling the movements of the main motor so that the broken semiconductor carrier moves backward or forward along with the main track; and
driving the broken semiconductor carrier to the maintain area.

16. The method according to claim 13, wherein the step of utilizing the controlling unit to control movements of the broken semiconductor carrier further comprises a step of:
utilizing the emergency switch to stop the main motor and the auxiliary motor.

17. The method according to claim 14, wherein the step of utilizing the controlling unit to control movements of the broken semiconductor carrier further comprises a step of:
utilizing the emergency switch to stop the main motor and the auxiliary motor.

18. The method according to claim 15, wherein the step of utilizing the controlling unit to control movements of the broken semiconductor carrier further comprises a step of:
utilizing the emergency switch to stop the main motor and the auxiliary motor.
